(19) United States
(12) Patent Application Publication
(10) Pub. No.: US 2004/0009319 A1
(43) Pub. Date: Jan. 15, 2004

(54) Highly reflective and highly emissive modified bituminous roofing membranes and shingles

(76) Inventors: Natalino Zanchetta, Reno, NV (US); Shaik Mohseen, Mountain Top, PA (US)

Correspondence Address: David I. Roche, BAKER & McKENZIE, 130 E. Randolph Drive, Chicago, IL, 60601, US

(21) Appl. No.: 10/195,748

(22) Filed: Jul. 15, 2002

(51) Int. Cl. B32B 3/00; B32B 9/00

(52) U.S. Cl. 428/40.1; 428/172

(57) ABSTRACT

A modified bituminous roof covering composite such as membranes and underlayments that comprise a thermoplastic (atactic polypropylene), elastomeric (styrene-butadiene-styrene) or thermoplastic polyolefin (TPO) modified bituminous roofing material with a reflective and emissive surface laminate forming a top surface of the composite to constitute a roof with thermal characteristics which substantially reduced the amount of radiant energy entering a structure with such a covering.

### BACKGROUND AND SUMMARY OF THE INVENTION

This invention relates to roofing membranes adapted for the waterproofing and sealing of substrate structures, particularly in roofing applications and to the method of manufacturing such membranes. More particularly, the present invention is in the field of roofing membranes based on a plastomeric modifier such as atactic polypropylene (APP) modified bituminous compound or an elastomeric modifier such as styrene-butadiene-styrene (SBS) modified bituminous compound or a thermoplastic polyolefin (TPO) modified bituminous compound, with a factory-applied surface laminate that provides high reflectivity and emissivity on the weathering (top) surface of the membrane, resulting in reduced energy needed to maintain optimal building temperatures, which in turn effects significant economical and environmental benefits, in addition to complying with the requirements of various regulatory bodies.

It is well known to use bituminous compositions for manufacturing waterproofing membranes, generally for roof covering. Modified bituminous prepared roofing, also referred to as modified asphalt roofing membrane, is typically manufactured using, as a base, a reinforcement carrier support sheet made of fabric such as polyester, fiberglass, or a combination of both, saturating and coating the top and bottom surfaces of the carrier with a modified bituminous coating material based on atactic polypropylene (APP), amorphous poly alpha olefin (APAO), themoplastic polyolefin (TPO), styrene-butadiene-styrene (SBS), styrene-ethylene-butadiene-styrene (SEBS), synthetic rubber or other asphaltic modifiers, that will enhance the properties of asphalt. Asphalt with high filler content is used for manufacturing shingles. It is known from prior art that modified bitumen roofing can be manufactured using ‘dual compounding technology’, whereby a compound based on atactic polypropylene (APP), amorphous poly alpha olefin (APAO), thermoplastic polyolefin (TPO), styrene-butadiene-styrene (SBS), styrene-ethylene-butadiene-styrene (SEBS), synthetic rubber or other asphaltic modifiers is applied on the top surface, and a separate heat-and-pressure-activated asphaltic adhesive compound to the bottom surface of the reinforcement.

Of the two general types of bituminous sheet materials used for roofing applications, i.e., bitumen-SBS and bitumen-APP materials, the bitumen-SBS products are more elastic, with greater flexibility at low temperatures. APP-based products, however, are more heat-resistant (due to a higher softening point), are more resistant against the effects of the atmosphere (especially ultra-violet rays) and less susceptible to being damaged by foot traffic. In a typical field installation, a base sheet is first applied to a deck (often plywood) of the roof using mechanical fasteners, hot mopping, cold application techniques or by being self-adhering. The base sheet, which is typically produced using a fiberglass reinforcement, is also typically saturated with modified bituminous compound. Modified bituminous roofing membranes (referred to as cap sheets) are applied on top of the base sheets, with the seams of adjacent rows in offset relation. Most APP-modified bitumen membranes are typically applied by torching the backside of the sheet and allowing the molten compound to form a bond with the substrate. Most SBS-modified bitumen membranes are set during the in-field application in hot mopping asphalt, torch-applied or adhered with cold-process adhesives, as described in U.S. Pat. No. 5,807,911 issued to Wentz, et al., on Sep. 1, 1992. Modified bitumen membranes that do not have factory-applied granule or foil surfacing need some form of field-applied ultraviolet protective coating. A suitable surfacing material such as mineral granules, slag, polyethylenesheet, polypropylenesheet, aluminum, copper, sand or talcum can be applied to the weathering surface of the roofing membrane. Depending on the type of product, Polyolefinic sheet or sand or siliconized release sheet is applied on the bottom surface to prevent sticking of adjacent sections of the roofing material and to the packaging, when the finished membrane is stored and transported in the form of rolls.

APP modified roofing membranes are usually torched and SBS modified roofing membranes are usually hot mopped. However, manufacturers of roofing materials have begun to offer another class of membranes called “self-adhered,” that is based on APP or SBS membranes. These membranes are generally made using dual compound technology, which consists of an APP or SBS compound on the top layer and a self-adhesive compound on the bottom layer. The manufacture of bituminous roofing material with multiple layers is well known. For example, U.S. Pat. Nos. 2,893,889; 4,755,409; 4,871,605; and EP Patent No. 903435 disclose membranes comprised of a core and a plurality of different layers of waterproofing material. The '409 patent also discloses a release sheet applied to one side of the membrane for purposes of protection. Products are in the market, which combine the more flexible and elastic bitumen-SBS upper layer with a self-adhesive lower surface. An example of such a product is Plura AD self-adhesive sold by Pluvitec S. p. A., described on the website of the seller at http://www.pluvitec.com.

It is well recognized that the ultraviolet rays from the sun are the most destructive to exposed asphalt surfaces. APP modified membranes have good ultraviolet resistance but SBS modified membranes lack this property. If left exposed to the elements, these membranes will be affected by the elements and will undergo premature degradation. Therefore top surfaces of modified bituminous roofing membranes, whether APP and SBS based, are typically surfaced with mineral granules or slates in the factory. These factory-applied coverings serve multiple purposes—protection from the elements, slip resistance on the roof, aesthetically appealing surfaces, etc. Such membranes form the top layers of the roofing construction and are called ‘cap’ sheets. There are also products in the market that are not provided with any factory-applied coverings. Such membranes that do not have factory-applied granule or foil surfacing typically have some form of field-applied ultraviolet protective coating. These are referred to as ‘smooth’ membranes and are generally coated at the jobsite with different types of coatings depending upon manufacturers' recommendations, economic considerations, desired performance, expected life, local environmental conditions, etc. These ultraviolet protective coatings contain solvents that are not desirable from an environmental point of view. For example, most coatings produce volatile organic compounds (VOC) and emissions that are harmful to the environment and to people. Furthermore, there is a large amount of labor associated with applying these ultraviolet protective coatings at the jobsite.

Energy consumption and costs have received much attention because when energy prices go up, a corresponding need has arisen for roof systems that assist in energy conservation. There has been a need for a roofing material with high reflectivity and high emissivity, especially in regions where cooling-degree days exceed heating-degree days. Several studies have been conducted that correlated the surface temperature of a building's roof to the energy required to maintain comfortable living conditions inside the building. Such studies have revealed that cooler roofs resulted in lower energy costs associated with heating the interior of the building. In addition to helping reduce energy costs, such products help to combat the “urban heat island” effect. “Urban heat island” is a condition whereby highly developed urban areas are noted to be warmer than surrounding countryside. A heat island can be portrayed as a “reverse oasis”—an urban area that is hotter than its surroundings. Most U. S. cities are considered to be heat islands. This phenomenon is the result of abundance of dark, heat-absorbing building materials on roofs, walls, streets, parking lots, etc. and the corresponding reduction in the amount of shade providing natural trees which results in higher temperatures in urban areas. Use of cool roofing materials reduces the urban heat island effect. One study conducted by Lawrence Berkley National Laboratory correlated temperature and air quality such that, in Los Angeles, for example, for every degree that the temperature rises above 70 degrees Fahrenheit, the incidence of smog increases three percent.

After extensive research and analysis, several governmental and non-governmental entities, research organizations, regulatory bodies and building standards-setting organizations have recognized the significance of benefits associated with energy savings through the use of cool roofing materials that help lower energy costs by maintaining lower surface temperatures. One of the several energy programs that have been launched recently is the Energy Star program implemented by the U.S. Department of Energy and the U.S. Environmental Protection Agency. Energy Star program is a national campaign to help protect the environment through energy efficient products and practices. Other nationwide programs include the Leadership in Energy and Environmental Design (LEED) program, ‘Green Roof’ program, ‘Cool Communities’ program coordinated by the U. S. Department of Energy, etc. Several local jurisdictions have also launched energy efficient roof programs. In 1994, the State of Georgia enacted what has come to be known as the Georgia White Roof Amendment that requires the use of additional insulation for roofing systems whose surfaces do not have test values of 75% or more for both reflectance and emissivity (See Table 1). In January of 2001, California launched its California Energy Commission's Cool Savings Program to allocate money towards the use of cooler roofing systems. The program, which is the first of its kind, grants a building owner a rebate of up to 20 cents/foot² of roof surface that contains cool roofing materials. Similarly, the Sacramento Municipal Utility District has instituted a rebate program to contractors of up to 20 cents/foot² for roof products that contain cool roofing materials. The city of Tucson, Ariz. is investigating ‘cool community’ mitigation measures to reduce heat island effect of hot roofing and paving materials. Other jurisdictions have gone even further by making energy efficient roofing program mandatory on all new roof installation. For example, the City of Chicago has enacted a new ordinance that requires the use of roofing materials to meet stringent requirements for energy efficiency such as 65% initial solar reflective properties and 50% solar reflective properties after three years, and 90% emissivity. Table 2 shows the requirements of the City of Chicago ordinance for energy efficient roofing. Several other metropolitan areas are set to follow these examples. Moreover, several industry groups such as the American Society of Testing and Materials (ASTM), American Society of Heating Refrigeration and Air Conditioning Engineers (ASHRAE), American Iron and Steel Institute (AISI) and Florida Solar Energy Center have instituted committees and commissioned research studies to better understand cool roof phenomenon. ASTM's Cool Construction Materials Committee has developed test standards to measure reflectivity and emissivity. AISI has embarked on a comparative testing program, called Three Year Panel Solar Reflectance Program, to measure reflective roof systems in order to determine what different levels of reflectance mean in terms of energy savings ratings. In 1998, a panel of experts established the Cool Roofing Ratings Council to develop methods for evaluating and labeling reflective roofing products in an accurate manner.

The term “cool roof” is used in the trade, in general, to refer to a roof surface that is highly reflective and highly emissive. A roof surface's primary characteristics that are critical to energy performance are solar reflectivity and emissivity. Reflectivity, also known as albedo, is the amount of incoming solar energy a roofing material's surface reflects and is measured as a percentage of solar heat reflected off of the roof. Emissivity is the amount of absorbed energy a roofing material radiates from itself because of the material's own heat and temperature, and is measured as a percentage of heat that comes off of a roof. In other words, reflectivity is the percentage of the sun's heat a roof keeps off the building structure, whereas Emissivity is the percentage of heat a roof lets out of a building structure. For a building to have improved thermal efficiency its roof system should have a high reflectivity, i.e., it should keep out a high percentage of the solar energy to which it is exposed. The roof system should also have high emissivity, i.e., it should let out a high percentage of the heat it has absorbed. Most surfaces have high reflectivity but low emissivity and vice-versa. For example, black asphaltic surface has low reflectivity but high emissivity, whereas aluminum metallic roof surface has high reflectivity but low emissivity. Conventional roof surfaces with low reflectivity and high emissivity heat to 160 to 190 degrees Fahrenheit during the summer. Metal or aluminum coated roofs with high reflectivity and low emissivity still warm to 140 to 170 degrees Fahrenheit. Cool roofs with both high reflectivity and high emissivity only reach 100 to 120 degrees Fahrenheit in the summer sun. In order to qualify as a cool roof, it is essential for the roofing material to possess both high reflectivity and high emissivity characteristics. Reflectivity is measured in accordance with ASTM E903 or ASTM E1918 and emissivity is determined in accordance with ASTM E408. Alternatively, solar reflectance index, which takes into account both reflectivity and emissivity, can be determined using ASTM E1980.

A cool roof, as defined by the U.S. Department of Energy as part of its Energy Star program, is a roof made with a product that meets or exceeds the Department's solar reflectance requirements, without compromising product quality or performance. See Table 3 below for Energy Star labeled roof specifications. Energy Star labeled roof product is a reflective roof product that lowers roof surface temperature by up to 100 degrees Fahrenheit, thereby decreasing the amount of heat transferred into a building's interior. The Energy Star labeled roof product provides several benefits, including cost and energy savings, extended roof life, and decreased pollution. Energy Star labeled roof products keep buildings cooler, reducing energy use, utility bills and decreasing pollution. Roofs undergo significant expansion and contraction as they heat and cool throughout the day. Heat absorbed can accelerate degradation due to UV rays and water. Reflective roof can reduce the amount of thermal shock that occurs on the roof surface and make the roof last longer. Also cool roofs are long lasting because they reflect the sun's ultraviolet rays that are responsible for breakdown of most conventional materials. To summarize, cool roofs offer many benefits, including decreased roofing maintenance and replacement costs, improved building comfort, reduced impact on surrounding air temperatures (urban heat island effect), reduced peak electricity demand, reduced waste stream of roofing debris due to extended roof life, etc. See Table 4 for California's Cool Savings Program performance specification. To qualify under Cool Savings Program, products must be Energy Star approved and meet the requirements specified in Table 4.

TABLE 1

| | PERFORMANCE SPECIFICATION |
|---|---|
| CHARACTERISTIC | Low Slope |
| Initial Solar Reflectance | ≧0.75 |
| Thermal Emissivity | ≧0.75 |

TABLE 2

| CHARACTERISTIC | PERFORMANCE SPECIFICATION |
|---|---|
| Initial Solar Reflectance | ≧0.65 |
| Maintenance of | ≧0.50 |
| Solar Reflectance | three years after installation |
| Thermal Emissivity | ≧0.90 |

TABLE 3

PERFORMANCE SPECIFICATION

| CHARACTERISTIC | Low Slope | Steep Slope |
|---|---|---|
| Initial Solar Reflectance | ≧0.65 | ≧0.25 |
| Maintenance of | ≧0.50 | ≧0.15 |
| Solar Reflectance | three years after | three years after |
| | installation | installation |

Low Slope Roofs: Surfaces with a slope of 2:12 inches or less

Steep Slope Roofs: Surfaces with a slope of greater than 2:12 inches as defined by ASTM E1918

TABLE 4

| CHARACTERISTIC | PERFORMANCE SPECIFICATION |
|---|---|
| Solar Reflectance | ≧0.65 |
| Emissivity | ≧0.80 |

Reflectivity and emissivity are dependent on the surface characteristics of the roofing membrane. Uncoated APP and SBS membranes have reflectivity values of 0.05 to 0.10 whereas white granulated surfaces possess reflectivity in the range of 0.20 to 0.40. Table 5 gives the reflectivity and emissivity values of various roofing materials. There are several coatings that are available in different colors that can be applied to the exposed surface of the sheet to improve the reflectivity and emissivity factors. Modified bitumen roofing products do not meet criteria for cool roofing without application of external coatings on the top surface of the roofing membrane after installation of the same at the jobsite. Such external treatment that is generally in the form of coatings has several drawbacks. Coatings are generally sprayed or rolled onto the main roof's surface area and are difficult to handle. These emit volatile organic compounds (VOC) that are harmful to the environment. Coatings are very expensive, and the process of application of coatings is labor intensive and time-consuming because of extensive surface preparation required. Most manufacturers of coatings stipulate stringent requirements for preparation of the surface of the membrane before application of the coatings—such instructions, when improperly followed, result in not achieving the desired results. Also most coatings are recommended to be applied a few days after installation of the roofing membrane, which extends the time needed for prompt completion of the roofing project. Moreover, most coatings lose their effectiveness in 5-8 years and therefore the roof needs to be recoated to attain its original properties. Also the amount of coating applied is very subjective; it depends on several factors such as the laborer, type of membrane, surface texture of the membrane, etc. All of the above factors determine the effectiveness of the performance of coatings over a period of time.

TABLE 5

| | Solar | Infrared |
|---|---|---|
| Product | Reflectance | Emissivity |
| Gray EPDM | 0.23 | 0.87 |
| White EPDM | 0.69 | 0.87 |
| Black EPDM | 0.06 | 0.86 |
| Hypalon (Rubber) | 0.76 | 0.91 |
| Smooth bitumen | 0.06 | 0.86 |
| White granular surfaced modified bitumen | 0.26 | 0.92 |
| White coated gravel on built-up roofing | 0.65 | 0.90 |
| Asphalt shingle - white granules | 0.36 | 0.91 |
| Asphalt shingle - black granules | 0.05 | 0.91 |
| Aluminum metal roof | 0.61 | 0.25 |
| Red clay tile | 0.33 | 0.90 |
| Red concrete tile | 0.18 | 0.91 |
| White concrete tile | 0.73 | 0.90 |

Although there are sheet materials commercially available that possess high reflective and high emissive properties, such sheets cannot be directly applied to the asphaltic compound due to a variety of reasons, such as processing difficulties due to heat sensitivities of the sheet, potential for delamination of the sheet caused by exudation of oil from modified asphaltic compound, and discoloration of the sheet due to exudation of oil from modified asphaltic compound, etc. A roofing material with a metallic or aluminum top layer and a bitumen coating bottom layer is known in the prior art. For example, U.S. Pat. No. 5,096,759, discloses a membrane containing a laminated top aluminum foil surface and a bottom bitumen coating surface. The surface laminate applied on the top layer of the membrane to impart cool roof properties constitutes the weathering surface. Such sheet is a lamination of multiple layers consisting of fabric, foil and other materials.

The present invention offers a product with a factory-applied surface laminate that meets the requirements of high reflectivity and high emissivity without the drawbacks associated with the usage of coatings to provide a cooler surface. Such factory-applied treatment is environmentally friendly, relatively inexpensive, highly reliable, and does not involve additional time for installation. The treatment is performed under rigid factory conditions and is not subject to the numerous variables in the field as with application of an external coating. The present invention relates to roofing membranes that have a top layer of atactic polypropylene (APP), amorphous poly alpha olefin (APAO), thermoplastic polyolefin (TPO), styrene-butadiene-styrene (SBS), styrene-ethylene-butadiene-styrene (SEBS) or synthetic rubber modified bituminous compound, whose composition utilizes bitumen (asphalt), plastomeric modifiers (APP), thermoplastic polyolefins (TPO), elastomeric modifiers (SBS and SEBS), and fillers and a bottom layer of atactic polypropylene (APP), amorphous poly alpha olefin (APAO), thermoplastic polyolfin (TPO), styrene-butadiene-styrene (SBS), styrene-ethylene-butadiene-styrene (SEBS), synthetic rubber modified bituminous compound or a self-adhesive compound, whose composition utilizes bitumen (asphalt), plastomeric modifiers (APP), thermoplastic polyolefins (TPO), elastomeric modifiers (SBS and SEBS), and fillers, and preferably have an adhesive strip on the side lap of the top surface of the sheet to facilitate easy and excellent adhesion, and a surface laminate on the top weathering surface to provide the desired reflectivity and emissivity characteristics. The surface laminate that is the subject of this invention provides enhanced reflectivity and emissivity because of its unique design features. This invention applies to standard APP modified and SBS modified membranes, self-adhesive membranes based on dual-compounding technology, underlayments such as employed under tile roofing and metal panels.

It is therefore one object of the present invention to provide roofing membranes with a surface laminate top surface to prevent heat from being absorbed by the roofing material by enhancing reflectivity and emissivity characteristics.

Another object of the present invention is to provide a non-carrier based roofing membrane with a high reflective, high emissive surface laminate on the top surface. Such sheet is based on self-adhesive compound and is adhered to existing roof surfaces to provide a cool roof. The membrane of this embodiment can be self-adhered to the top surfaces of existing roofs, substituting the need for application of coatings.

Yet another object of the present invention is to provide a seam tape that is made from the abovementioned sheets. Such seam tape can be silver or white in color and cut into narrower widths, preferably 6-9 inches. These tapes can be coated with a pressure-sensitive adhesive on the bottom surface and subsequently covered with a siliconized release sheet or siliconized kraft paper to protect adjacent layers from sticking. When torch grade ‘cool roof’ modified membranes are applied on the rooftop, the backside of one roll is torched and attached to the overlap area of an adjacent roll. Similarly when mop grade ‘cool roof’ modified membranes are applied on the rooftop, the backside of one roll is hot mopped and attached to the overlap area of an adjacent roll. During this process of application, the surface laminate on the overlap areas of the membrane could experience heat distortion. ‘Cool roof’ seam tapes of the present invention could be applied over the end lap and side lap joint areas to provide a continuous ‘cool roof’ covering. Use of such seam tape also serves the purpose of protecting the exposed edges of the membrane from deterioration due to ultraviolet rays.

### BRIEF DESCRIPTION OF THE DRAWINGS

FIG. 1 is an exploded view of the roofing membrane composite sheet.

FIG. 2 is a side view of the inventive laminate.

FIG. 3 is another embodiment of the inventive laminate.

FIG. 4 is a top view of the composite sheet illustrating the adhesive strips on the side and end laps and adhered to a roofing substrate structure.

FIG. 5 is a view of the composite sheet manufacturing process and one method of applying the laminate surface on the composite upper layer.

FIG. 6 is a view of a seam tape over the side lap.

FIG. 7 is a view of a seam tape over the end lap.

### DETAILED DESCRIPTION OF THE INVENTION

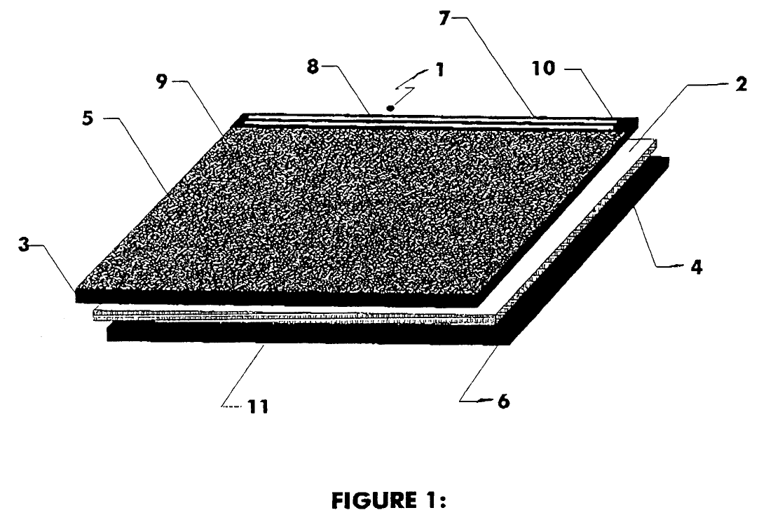

Referring now to the figures, FIG. 1 illustrates a roofing membrane composite of this invention in an exploded view with a laminate surface as described in detail below. A modified bituminous cool roofing membrane of the present invention is a composite sheet made with modified asphalt coatings and a reinforcing carrier. Specifically, the composite membrane 1 includes a top asphaltic coating layer 3, a reinforcing carrier 2, and a bottom asphaltic coating layer 4. The top and bottom layers, 3 and 4, respectively, forming oppositely exposed upper and lower surfaces, 5 and 6, respectively. Between the top and bottom layers, 3 and 4 respectively, is a carrier support sheet 2, preferably made of a fiberglass or polyester material. Polyester is generally characterized by unit weight and can be in the range of 100 grams/meter² to 250 grams/meter², with a preferred weight of 170 grams/meter². Fiberglass employed for this application is also characterized by unit weight and can be in the range of 50 grams/meter² to 150 grams/meter², with a preferred weight of 90 grams/meter². Alternatively, the reinforcing carrier support sheet 2 may be a combination of both polyester and fiberglass, creating a stronger reinforcement carrier sheet 2. Such reinforcement carrier 2 may also be of a textile variety. As will become hereinafter apparent, the lower exposed surface 6 of the bottom asphaltic coating layer 4 is a non-weathering surface adapted to be adhered directly to the roof or underlayment (hereinafter referred to as underlying surface) by torching, hot mopping, cold application using adhesives, or self-adhered. A specially engineered surface laminate 9, 36 to 37 inches in width, is laminated to the upper surface 7 of the composite sheet 1 to impart reflectivity and emissivity characteristics to a bituminous base membrane. Furthermore, as shown in FIG. 1, an adhesive coating 8 can be applied on the selvage edge overlapping area (i.e., side lap 7), and a selvage release sheet 10, that is approximately 3 to 4 inches in width, can be placed along the length of the roll over this adhesive coating 8 in order to prevent the roll surfaces from sticking together during manufacture, transportation and storage of the material. The adhesive coating 8 enhances the bond strength at the lap joints and is generally an asphaltic self-adhesive compound or commercially available pressure-sensitive adhesive based on rubber, acrylates or silicones. The selvage release sheet 10 can be made of polyolefins such as polyethylene, polypropylene or polyester and can range in thickness from 0.5 mil (12 microns) to 2 mil (50 micron). A 1.5 mil (37.5 micron) thick, polyester (PET) sheet is preferred for this application. Such sheet is treated with a release agent, such as silicone, on the side that comes into contact with the adhesive coating in order to facilitate easy release of the sheet during installation of the membrane on the roof or underlying surface. Positioned on the lower exposed surface 6 of the bottom asphaltic coating layer 4 is a backing agent 11 of polyolefinic sheet, sand or release liner made of silicone treated polypropylene, polyethylene or polyester release sheet. The polyolefinic sheet is typically based on polypropylene or polyethylene with a thickness of 8 to 12 microns and is micro-perforated to allow moisture or air trapped between the sheet and asphaltic compound during the manufacturing process to escape. Such sheets are fused to the surface of the bituminous compound during production.

Sand employed for this purpose is very finely ground. Release liner is typically a polypropylene, polyethylene or polyester sheet that is 40 to 70 micron in thickness and siliconized on the surface that contacts the bottom asphaltic compound layer 4. It is preferred that the release liner be of white color on the exposed (unsiliconized) side so as to reflect solar energy and thereby keep the adhesive bottom layer relatively cool. Optionally, a siliconized kraft paper or a composite of paper and sheet can be adhered to the bottom adhesive layer of the composite sheet. Kraft paper employed for this application is treated with a release agent such as silicone on the side that comes into contact with the bottom layer 4 in order to permit easy release during installation of the membrane on the roof or underlying surface. Of course, during application to the underlying surface, the polyolefinic sheet is torched in the case of torch products, sand is mopped to in the case of ‘hot mopped’ products, and the release sheet is removed in the case of self-adhered products in order to allow the sticky underside of the modified bitumen membrane to adhere to the underlying surface. Also removed at the time of roofing membrane installation is the selvage release sheet 10. Such composite membranes 1 can be APP or SBS based and provided with the appropriate backing agent 11 depending upon the type of application technique which includes torching, hot mopping, cold application using adhesives or self-adhered.

If the top asphaltic compound layer 3 of the present invention is APP based, it is characterized in that it comprises a mixture consisting of the following: 5% to 25% of a mixture of polypropylene modifiers comprising of: (a) isotactic polypropylene; (b) ethylene-propylene copolymer; (c) atactic polypropylene, and (d) polyethylene, preferably sheet grade material, 8% to 70% of fillers such as limestone, talc, fly ash, volcanic ash, graphite, carbon black, silica or china clay, and 45% to 75% of asphalt. Polyethylene used in the APP formulation can be high density polyethylene (HDPE) or low density polyethylene (LDPE), virgin or recycled material. APP formulations may be adjusted slightly to account for seasonal temperature fluctuations, such as, very hard compound to be used during the summer months and a compound with medium hardness to be used during the winter months. In the place of APP, commercially available thermoplastic polyolefin (TPO) can be substituted as well. Such a mix should have a viscosity of 2,000 to 20,000 cPs at 180 degrees Celsius (356 degrees Fahrenheit), a ring and ball softening point temperature greater than 130 degrees Celsius (266 degrees Fahrenheit), and a needle penetration value within the range of 40 to 140 dmm at 60 degrees Celsius (140 degrees Fahrenheit), with a preferred value of 80 dmm. All tests values are determined using appropriate ASTM test methods and standards. The APP compound can further contain a tackifying resin in amounts ranging from 0% to 2% to improve adhesion at lap joints and assist in adhering the specially treated laminate surface 9 to the asphaltic compound top layer 3. Additionally, in order to achieve fire ratings as classified by Underwriters' Laboratories (UL), special fire retardant additives may be used as filler material. Typical fire retardants employed include calcium borate, magnesium borate, a mixture of antimony tri-oxide and deca bromo diphenyl oxide, etc. These are used as replacement for existing filler material such as limestone, talc, fly ash, volcanic ash, graphite, carbon black, silica or china clay or in conjunction with these filler materials. A minimum of 10% of the fire retardant material is required to achieve the desired performance during fire testing.

If the top asphaltic compound layer 3 of the present invention is SBS based, it is characterized in that it comprises a mixture consisting of the following: 5% to 15% of a mixture of rubber modifiers comprising of: (a) styrene-butadiene-styrene; (b) styrene-isoprene-styrene; and (c) styrene-ethylene-butadiene-styrene, 8% to 70% of filler such as limestone, talc, fly ash, volcanic ash, graphite, carbon black, silica or china clay, and 45% to 75% of asphalt. The SBS selected for use can be of a linear or radial configuration. SBS formulations may be adjusted slightly to account for seasonal temperature fluctuations, such as, very hard compound to be used during the summer months and a compound with medium hardness to be used during the winter months. Such formulations may contain some proportions of recycled ground tire rubber or commercially available Ethylene Propylene Rubber (EPR) as well. Such a mix should have a viscosity of 2,000 to 20,000 cPs at 180 degrees Celsius (356 degrees Fahrenheit), a ring and ball softening point temperature greater than 110 degrees Celsius (230 degrees Fahrenheit), and a needle penetration value within the range of 80 to 160 dmm at 60 degrees Celsius (140 degrees Fahrenheit), with a preferred value of 100 dmm. All tests values are determined using appropriate ASTM test methods and standards. The SBS compound can further contain a tackifying resin in amounts ranging from 0% to 2% to improve adhesion at lap joints and assist in adhering the specially treated laminate surface 9 to the asphaltic compound top layer 3. Additionally, in order to achieve fire ratings as classified by Underwriters' Laboratories (UL), special fire retardant additives may be used as filler material. Typical fire retardants employed include calcium borate, magnesium borate, a mixture of antimony tri-oxide and deca bromo diphenyl oxide, etc. These are used as replacement for existing filler material such as limestone, talc, fly ash, volcanic ash, graphite, carbon black, silica or china clay or in conjunction with these filler materials. A minimum of 10% of the fire retardant material is required to achieve the desired performance during fire testing.

The bottom asphaltic compound layer 4 can be the same APP or SBS compound as described above. Alternatively, a separate self-adhesive compound may be used in the case of dual-compound membranes. The bottom adhesive layer 4 of the dual-compound asphaltic coating is an aggressive adhesive that is applied on the backside of the carrier sheet 2. The bottom adhesive layer 4 should possess a reasonable shelf life and excellent adhesion characteristics and have sufficient surface tack for rooftop installation, yet should not be too sticky that one cannot remove the release liner at high temperatures. The adhesive bottom layer 4 generally comprises a mixture of the following ingredients: 3% to 10% of styrene-butadiene-styrene copolymer, 0% to 5% of styrene-isoprene-styrene copolymer, 6% to 25% of hydrocarbon tackifying resins, 8% to 40% of mineral stabilizers such as limestone, talc, fly ash, volcanic ash, graphite, carbon black, silica or china clay, and the balance being asphalt, having a needle penetration value of at least 140 dmm at 25 degrees Celsius (77 degrees Fahrenheit) using relevant ASTM test methods.

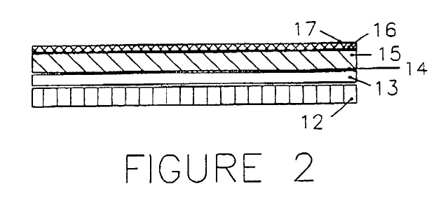

Referring now to FIG. 2, in one preferred embodiment, the laminate surface 9 that is employed in this application is a laminate of a polyolefinic fabric 12 and a polyolefinic sheet 15 bonded together using a bonding adhesive 13. The polyolefinic fabric 12 can be white or black in color, made of polypropylene or polyester, and have a unit weight ranging from 15 grams/meter² to 140 grams/meter^{2.} Bonding adhesive 13 used as bonding agent can be low density polyethylene (LDPE), acrylics or ethyl acrylic acid (EAA), of thickness in the range of 0.5 mil (12.5 microns) to 1.5 mil (37.5 microns). Polyolefinic sheet 15 on the top surface can be commercially available polyester (PET) or PolyVinyl Fluoride (PVF), of thickness ranging from 1 mil (25 micron) to 2 mil (50 micron), clear or white in color, and with or without ultraviolet inhibitors inside the polymeric material. The clear sheet can be metallized using vapor deposition techniques to yield a silver look, while the use of a white color sheet can be used to yield a white look. The sheet 15 is oriented such that the metallized surface 14 faces downward in the direction of the fabric 12, i.e., the metallized surface 14 comes into contact with the bonding adhesive 13. Because the sheet 15 carries the metal on its underside, the silver color is protected from becoming discolored or damaged during attachment to the top asphaltic compound layer 3 and during installation of the roofing membranes. Also, metallizing the underside permits the metallized surface 14 not to be exposed to the elements where it might be eroded by action of the weather or wear away by foot traffic. Thus, a silver color and white color surfaced roofing composite membrane 1 can be achieved. The success of the laminate surface 9 primarily depends on the ultraviolet resistant nature of the polyolefinic sheet 15. White sheets have pigments such as titanium di-oxide added in order give the white color, and the pigment is carried by a sheet. “Carried by”, as used herein includes mixed into the material comprising a sheet and applied as a coating to a sheet. Such sheets are opaque and do not allow UV light to pass through them. These sheets are also available with built-in ultraviolet inhibitors to absorb any UV light that may enter inside. A geometric pattern 17 can be embossed on the top surface of this sheet 15 to enhance aesthetics, provide slip resistance to the surface, and mask any surface imperfections.

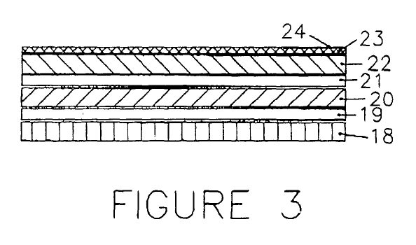

FIG. 3 shows another preferred embodiment of the cool roof surface laminate. In this case, the structure is a laminate of a polyolefinic fabric 18, aluminum foil 20 and a polyolefinic sheet 22 bonded together using a bonding adhesive.

TABLE 6

| Product | Solar Reflectance | Infrared Emittance |
|---|---|---|
| Modified Bituminous White | 0.77 | 0.90 |
| Roofing Membrane | | |
| Modified Bituminous Silver | 0.82 | 0.80 |
| Roofing Membrane | | |

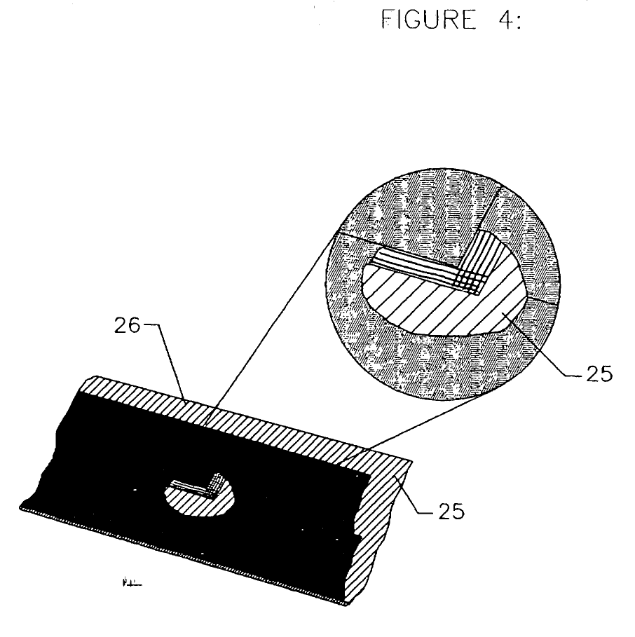

Referring now to FIG. 4, the composite sheet 1 is shown as applied to the underlying surface 25, which can be the roof deck itself or another base sheet or underlayment. The composite sheet 1 is shown with a cutout exploded view illustrating the side lap 7, which runs longitudinally along one lengthwise edge of the composite sheet 1, and the end lap 26, which runs transversely along one widthwise edge of the composite sheet 1. As illustrated, the composite sheet 1 is applied to the underlying surface 25 in successive rows. The composite sheets 1 can be adhered to each other along the side lap 7 and end lap 26 to create a watertight or connecting bond between successive or adjacent composite sheets 1.

It is well known that modified bitumen based roofing materials are used all over the country throughout the year. It is also known that the required bonding strength is achieved in products based on self-adhesive technology in the presence of heat and pressure, which act as catalyst to attain a permanent seal. However when these products are used during colder climatic conditions, the element of “heat” is lacking or insufficient. Whereas it is possible to recommend the use of a ‘hot air gun’ to activate the adhesive at the lap seams, it was found that addition of a thin layer or strips of tackifying resin or commercially available pressure-sensitive adhesive (PSA) or PolyVinyl Butyral (PVB) to the side lap and end lap, provided a good initial seal between adjacent rolls, before a strong, permanent lap bond can be achieved over time. This feature allows the application of such membranes under low temperature conditions, without compromising the integrity of the roof. To achieve a self-adhering cool roof, it is important to have the highly reflective and emissive laminate over the major portion of the upper exposed surface of the roof covering, and to leave a side lap and end lap of bituminous material exposed. The end and side laps are used to connect to the underside of adjacent rolls of cool roof covering. Depending upon the climate where the material is used, it may also be desirable to have the bonding of the side lap (and perhaps the end lap, as well) enhanced by the presence of additional strip of adhesive covered with a releasesheet.

By the application of a thin layer or adhesive coating, i.e., a width of adhesive coating, consisting of a tackifying resin or commercially available pressure-sensitive adhesive (PSA) or PolyVinyl Butyral (PVB) to the side lap and end lap, a good initial seal between adjacent rolls is obtained. The initial seal is adequate to last at least until the warmth of a summer season brings heat sufficient to permanently bond the entire lap joint. This feature allows the application of such cool roof membranes under low temperature conditions, without compromising the integrity of the roof, and without the time, danger and expense of field-applied heat.

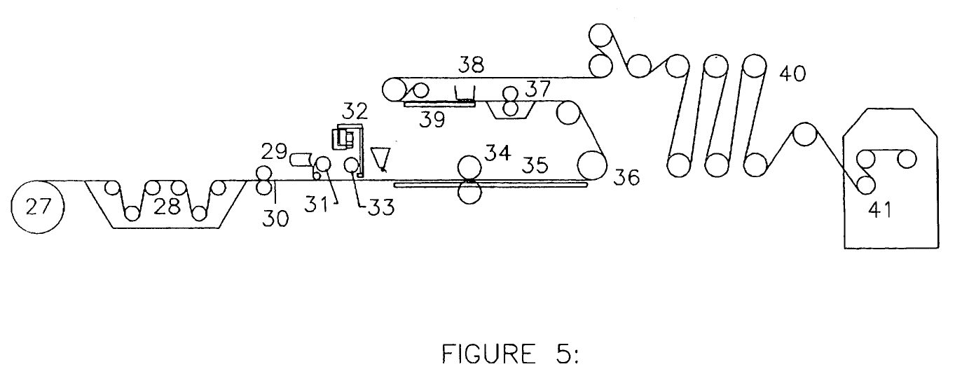

FIG. 5 illustrates one process of manufacture of a cool roofing modified bitumen composite membrane 1. One or more reinforcement carrier sheets 2, which may be polyester, fiberglass, or a polyester/fiberglass combination, is unwound from a mat unwinding station 27, and saturated with the APP or SBS modified bitumen compound top layer 3 in the saturation tank 28. Coating thickness is controlled using calender rolls 29 immediately after the saturated carrier sheet 2 comes out of the saturation tank 28. In the case of dual compound membranes which have a self-adhesive coating on the bottom surface, compound from the carrier sheet back side 2a is scraped off using a scraper 30 in order to facilitate application of the self-adhesive compound bottom layer 4 on the carrier back side 2a of the carrier sheet 2 during a later stage in the manufacturing process. Afterwards, adhesive strips 8 are applied on the side lap 7 using adhesive applicator 31. Directly following these applications, selvage release sheet 10 is applied on the adhesive strip 8 on the side lap 7 using a applicator 32, and following this application, surface laminate 9 is applied using the surfacing applicator 33. Immediately following this application, the surface laminate 9 is pressed into the compound using press rollers 34 in order to bond the surface laminate 9 to the top layer 3 such that the bottom layer of the surface laminate 9, namely the fabric, thermally fuses into the bituminous compound. The composite sheet 1 undergoes cooling by traveling on a chilled water bath 35 and over cooling drums 36, and is typically cooled to about 200 degrees Fahrenheit. After traveling through a series of turns and gears, the composite sheet 1 is inverted such that the upper-exposed surface 5 of the composite sheet 1 is now on the bottom side. In the case of dual-compound membranes, self-adhesive compound bottom layer 4 is applied at the coating vat 37. The composite sheet 1 travels over a cooling belt to permit cooling of the top and bottom compounds, top layer 3 and bottom layer 4, respectively. Depending upon the nature of the product (APP modified, SBS modified or self-adhesive), a backing agent 11 of polyolefinic sheet or sand is applied to the compound bottom layer 6 using the sheet or sand applicator 38 and release liner is applied to the compound bottom layer 6 using the release applicator 39. Then, the composite sheet 1 travels through the accumulator 40 to the winder 41 where it is cut to the required length and wound into rolls.

Another process of manufacture of a cool roof membrane is to unroll the cool roof laminate 9 from the mat unwinding station 27 such that the fabric surface 12 is facing upwards. APP or SBS compound is poured on the top surface of the laminate 9 at the saturation tank 28 and thickness is controlled using calender rolls 29. Immediately following this application, depending upon the nature of the product (APP modified, SBS modified or self-adhesive), a backing agent 11 of polyolefinic sheet or sand is applied to the compound bottom layer 6 using the sheet or sand applicator 38, and release liner is applied to the compound bottom layer 6 using the release sheet applicator 39. Then, the composite sheet 1 travels through the accumulator 40 to the winder 41 where it is cut to the required length and wound into rolls.

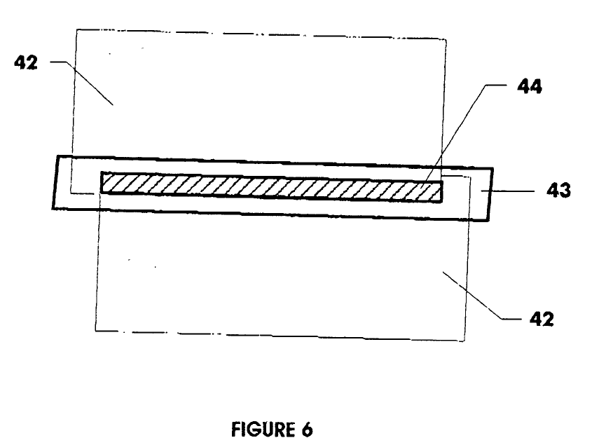

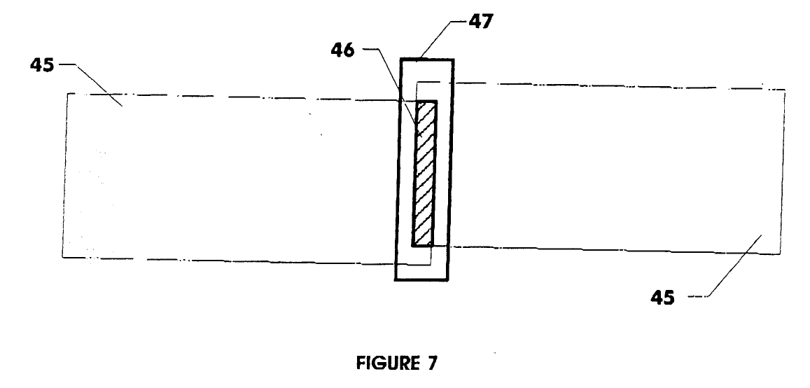

FIGS. 6 and 7 refer to a cool roof seam tape over the side lap and end lap respectively. Referring now to FIG. 6, two sheets 42 are overlapped at the side lap 43. A cool roof seam tape 44 is applied over this area. FIG. 7 shows two rolls 45 overlapped at the end lap 46 and covered using a seam tape 47. Such seam tapes can be silver or white in color and cut into narrower widths, preferably 6-9 inches. These tapes can be coated with a pressure-sensitive adhesive on the bottom surface and subsequently covered with a siliconized release sheet or siliconized kraft paper to protect adjacent layers from sticking. When torch grade ‘cool roof’ modified membranes are applied on the rooftop, the backside of one roll is torched and attached to the overlap area of an adjacent roll. Similarly when mop grade ‘cool roof’ modified membranes are applied on the rooftop, the backside of one roll is hot mopped and attached to the overlap area of an adjacent roll. During this process of application, the surface laminate on the overlap areas of the membrane could experience heat distortion. ‘Cool roof’ seam tapes of the present invention could be applied over the end lap and side lap joint areas to provide a continuous ‘cool roof’ covering. Use of such seam tape also serves the purpose of protecting the exposed edges of the membrane from deterioration due to ultraviolet rays.

The foregoing detailed description shows examples of embodiments of the present inventions. It will be understood by those of skill in the art that the inventions described herein, as claimed below, may be practiced in a number of alternative ways and that variations and modifications from the embodiments shown and described herein may still embody the spirit and scope of the appended claims.

What is claimed is:

1. A highly reflective and highly emissive roof covering comprising:
a laminate comprised of a composite upper sheet and a carrier fabric, whereby said laminate reflects and emits radiant energy away from said fabric and materials underlying said fabric,
said laminate carried by a bituminous roofing material.

2. A highly reflective and highly emissive roof covering as described in claim 1, wherein:
said laminate is rendered ultraviolet resistant by an ultraviolet resistant coating applied to an upper surface of said laminate.

3. A highly reflective and highly emissive roof covering as described in claim 1, wherein:
said upper sheet is comprised of PVF, and said laminate is rendered ultraviolet resistant by an ultraviolet resistant material mixed with material comprising said upper sheet.

4. A highly reflective and highly emissive roof covering as described in claim 1, wherein:
said bituminous roofing material is comprised of first upper layer and said second lower layer, said upper layer is modified with a modifier selected from the group consisting of: atactic polypropylene, amorphous poly alpha olefin, thermoplastic polyolefin, styrene-butadiene-styrene, styrene-ethylene-butadiene-styrene, and synthetic rubber.

5. A highly reflective and highly emissive roof covering as described in claim 1, wherein:
the upper surface of said laminate is embossed to reduce the slipperiness of said upper surface.

6. A highly reflective and highly emissive roof covering as described in claim 1, wherein:
said laminate comprises a metal layer carried by said sheet;
said metal layer being selected from the group consisting of: a vapor deposited metal layer applied directly to said sheet, and a discrete metal sheet adhered to said sheet by a bonding adhesive.

7. A highly reflective and highly emissive roof covering as described in claim 1, wherein:
a white pigment is carried by the material comprising said sheet.

8. A highly reflective and highly emissive roof covering as described in claim 1, wherein:
said film is translucent and a bonding adhesive which is white-colored adheres said fabric to said film.

9. A highly reflective and highly emissive roof covering as described in claim 1, wherein:
said laminate contains a layer of aluminum foil disposed between said film and said fabric layer.

10. A highly reflective and highly emissive roof covering as described in claim 1, wherein:
said covering is cut into sections to provide a seam tape.

11. A highly reflective and highly emissive roof covering as described in claim 10, wherein:
said covering being in a roll form and having bituminous material exposed at its side edges forming side laps, and a release film is applied to each side lap
a release liner covering said bottom layer.

12. A highly reflective and highly emissive roof covering as described in claim 11, wherein:
a coating of adhesive strips is applied to said side laps.

13. A highly reflective and highly emissive roof covering comprising:
a laminate comprised of a composite upper sheet said upper sheet made of PVF and a carrier fabric, whereby said laminate reflects and emits radiant energy away from said fabric and materials underlying said fabric,
said laminate comprising a metal layer carried by said sheet,
said metal layer being selected from the group consisting of: a vapor deposited metal layer applied directly to said sheet, and a discrete metal sheet adhered to said sheet by a bonding adhesive,
said laminate carried by a bituminous roofing material.

14. A highly reflective and highly emissive roof covering as described in claim 13, wherein:
said laminate is rendered ultraviolet resistant by an ultraviolet resistant coating applied to an upper surface of said laminate.

15. A highly reflective and highly emissive roof covering as described in claim 13, wherein:
said laminate being further rendered ultraviolet resistant by an ultraviolet resistant material mixed with material comprising said upper sheet.

16. A highly reflective and highly emissive roof covering as described in claim 13, wherein:
said bituminous roofing material is comprised of first upper layer and said second lower layer, said upper layer is modified with a modifier selected from the group consisting of: atactic polypropylene, amorphous poly alpha olefin, thermoplastic polyolefin, styrene-butadiene-styrene, styrene-ethylene-butadiene-styrene, and synthetic rubber.

17. A highly reflective and highly emissive roof covering as described in claim 13, wherein:
the upper surface of said laminate is embossed to reduce the slipperiness of said upper surface.

18. A highly reflective and highly emissive roof covering as described in claim 13, wherein:
a white pigment is carried by the material comprising said sheet.

19. A highly reflective and highly emissive roof covering as described in claim 13, wherein:
said PVF sheet is translucent and a bonding adhesive which is white-colored adheres said fabric to said film.

20. A highly reflective and highly emissive roof covering as described in claim 13, wherein:
said covering is cut into sections to provide a seam tape.

21. A highly reflective and highly emissive roof covering as described in claim 13, wherein:
said covering being in a roll form and having bituminous material exposed at its side edges forming side laps, and a release film is applied to each side lap over a layer of adhesive applied to said side laps.

22. A highly reflective and highly emissive roof covering comprising:
a laminate comprised of a composite upper sheet and a carrier fabric, whereby said laminate reflects and emits radiant energy away from said fabric and materials underlying said fabric,
said laminate rendered reflective and highly emissive by a layer selected from the group consisting of: a white colored pigment mixed into material comprising said sheet, a vapor deposited metal layer applied directly to said sheet, a discrete metal sheet adhered to said sheet by a bonding adhesive, a combination thereof,
said laminate carried by a bituminous roofing material, said bituminous roofing material is comprised of first upper layer and said second lower layer, said upper layer is modified with a modifier selected from the group consisting of: atactic polypropylene, amorphous poly alpha olefin, thermoplastic polyolefin, styrene-butadiene-styrene, styrene-ethylene-butadiene-styrene, and synthetic rubber.

23. A highly reflective and highly emissive roof covering as described in claim 22, wherein:
said laminate is rendered ultraviolet resistant by an ultraviolet resistant coating applied to an upper surface of said laminate.

24. A highly reflective and highly emissive roof covering as described in claim 22, wherein:
ultraviolet resistant material is mixed with material comprising said upper sheet.

25. A highly reflective and highly emissive roof covering as described in claim 22, wherein:
said sheet is made of PVF and said fabric is made of PET, and the upper surface of said laminate is embossed to reduce the slipperiness of said upper surface.

26. A highly reflective and highly emissive roof covering as described in claim 22, wherein:
a white pigment is incorporated into the material comprising said sheet.

27. A highly reflective and highly emissive roof covering as described in claim 22, wherein:
said sheet made of translucent PVF and a bonding adhesive which is white-colored adheres said fabric to said film.

28. A highly reflective and highly emissive roof covering as described in claim 22, wherein:
said covering is cut into sections to provide a seam tape.

29. A highly reflective and highly emissive roof covering as described in claim 22, wherein:
said covering being in a roll form and having bituminous material exposed at its side edges forming side laps, and a release film is applied to each side lap over a layer of adhesive applied to said side laps.
